(19) United States
(12) Patent Application Publication
(10) Pub. No.: US 2002/0182337 A1
(43) Pub. Date: Dec. 5, 2002

(54) Mechanical plating of zinc alloys

(76) Inventors: Ian Bartlett, Birmingham (GB); Ernest Long, Coventry (GB); Anthony Rowan, Leicestershire (GB); Anthony Wall, West Midlands (GB)

Correspondence Address: John L. Cordani, Carmody & Torrance LLP, 50 Leavenworth Street, P.O. Box 1110, Waterbury, CT, 06721-1110, US

(21) Appl. No.: 09/870,165

(22) Filed: May 30, 2001

(51) Int. Cl. B05D 1/18; B05D 7/00

(52) U.S. Cl. 427/436; 427/216; 427/217

(57) ABSTRACT

A process for mechanical plating zinc alloys onto metal substrates is disclosed. The process is particularly suited to plating zinc-aluminium or zinc-manganese alloys onto aluminium or magnesium substrates. The zinc alloy particles are immersion coated with tin prior to plating upon the metal substrate. Fluoride ions are preferably added to the plating media to increase plating efficiency, particularly when zinc aluminium alloys are being plated.

### FIELD OF THE INVENTION

The present invention relates to the mechanical plating of metal workpieces or components with an alloy coating, and in particular with an alloy coating comprising binary or ternary zinc-manganese or zinc-aluminium alloys.

### BACKGROUND

The process of mechanical plating with metal and alloy coatings is, in general terms, well known. In the mechanical plating process, the coating (plating) metal or metals is/are initially in particulate (powder) form and, together with the substrate to be coated, a mechanical force is applied sufficient to cause adhesion between the metal particles and the substrate, thereby forming the coating. The mechanical force is usually achieved by placing the substrate to be coated, a solid impaction medium (usually glass beads), other materials which promote plating, and the particulate coating metal(s) in a rotating ball mill or tumbling barrel. Rotation of the ball mill or tumbling barrel imparts kinetic energy to the impaction medium which is then transferred to the particles of the coating metal(s) so that they become impacted onto the substrate and the desired metal or alloy coating is formed.

Early work in the field of mechanical plating was disclosed in U.S. Pat. Nos. 2,640,001, 2,640,002, 2,689,808 and 2,723,204. Typically, these mechanical plating processes were undertaken in the presence of liquid containing additives to improve the efficiency of plating and/or the quality of the metal deposited. These additives generally included surfactants, film-forming materials, anti-foaming agents, and dispersants. These materials were often added in specific combinations as “promoters”. U.S. Pat. No. 3,460,977 discloses promoter chemicals with specific surfactants and organic acids. U.S. Pat. Nos. 3,286,356 and 4,389,431 disclose incrementally adding the promoter chemical and/or the metal particles to the plating barrel in successive additions in order to optimise the density and uniformity of the coatings.

U.S. Pat. No. 3,531,315 discloses performing a mechanical plating process in the presence of a strong acid. Prior to this, the actual plating process was carried out in the presence of weak organic acids such as citric acid, whereas strong acids were used in an initial cleaning operation for the substrate. This required that the plating barrel was thoroughly rinsed to remove the strong acids before the plating cycle could commence. The ability to perform the entire operation in the presence of strong acids without the need for intermediate rinsing rendered the mechanical plating process very economical.

In order to achieve alloy coatings, conventional processes have relied on mixtures of individual metal powders. However, such mixtures often do not lead to a coated alloy of the desired composition. For example, one component of the metal powder mixture may be deposited to a greater extent than other components of the mixture, so that said one component predominates in the resulting alloy.

In the automotive industry, aluminium and magnesium are becoming much more widely used for the construction of vehicles in order to meet demands for higher performance and lower fuel consumption. This in turn generates a demand for fasteners having a coating which minimises contact corrosion with aluminium and with magnesium. Alloys which could perform well in contact with aluminium and magnesium include binary and ternary Zn—Mn and Zn—Al alloys. A need therefore exists for depositing these alloys in a commercially acceptable manner and in a method which produces a commercially acceptable coating, particularly on aluminium and magnesium substrates.

There is currently no simple way to produce these alloy coatings. Zinc-manganese coatings can be produced by electrodeposition, but a manganese content higher than 2% is difficult to obtain under barrel electroplating conditions. High current densities are usually required to obtain manganese content above this value. Zinc-aluminium alloys cannot be electrodeposited at all from aqueous solutions. Mixtures of zinc and aluminium powders cannot currently effectively be used to deposit zinc-aluminium alloys by mechanical deposition. Zinc-manganese alloys cannot currently be deposited by mechanical means using mixtures of zinc and manganese powders. This is due to the reactive nature of manganese.

WO 00/68464 describes a near neutral electroplating system for zinc-manganese alloys which can produce alloys which are relatively high in zinc, but the disclosed process has a low efficiency of only about 40%. Another electroplating process is disclosed in JP 07278875. In this process, a rack plating system is used in order to achieve zinc-manganese alloy coatings of the required composition. However, a rack-plating process is commercially entirely unsatisfactory for the production of small parts such as fasteners. Under barrel electroplating conditions (as is required for fasteners) the process described in JP 07278875 cannot produce an alloy coating of the required composition. For fasteners used in the automotive industry, a zinc-manganese alloy including about 5-10% manganese is specified by the automotive manufacturers.

### SUMMARY OF THE INVENTION

Thus, the present invention relates to a process for plating metal parts with a zinc alloy, particularly a binary or ternary zinc-manganese or zinc-aluminium alloy coating, by means of a mechanical plating process employing a zinc alloy powder of substantially the desired alloy composition. The mechanical plating process of the invention provides an alloy coating of the required composition with good adhesion to the substrate and, in comparison to electroplating processes, provides improved control of the final plated alloy composition and greater plating efficiency. Plating efficiencies of at least 60% can be achieved. The process of the invention is particularly useful in plating these alloys over aluminium and magnesium surfaces.

### DETAILED DESCRIPTION

It should be noted that, in general, many alloy compositions are not suitable for mechanical alloy plating from an alloy powder. For example, many alloy combinations are excluded because the resulting powders are too hard to compress (cold weld) by impaction onto the substrate surface. Other alloys (such as zinc-aluminium) may react rapidly (especially in fine powder form) to form stable oxides which greatly impair the mechanical plating process. However, the inventors here have found that binary zinc-manganese or zinc-aluminium alloys or ternary or greater alloys of zinc-manganese or zinc-aluminium, such as zinc-tin-manganese alloys or zinc-manganese-aluminium alloys can be successfully mechanically plated onto a variety of substrates including aluminium and magnesium.

The alloy powders used in the present invention are mechanically plated onto the required metal substrate (such as fasteners) by plating techniques employing an “immersion” metal which can effectively coat (immersion plate upon) the alloy powder particles. The alloy powders used in the process of the invention will preferably have a particle size distribution in the range of from about 3.5 microns to about 11.6 microns with a mean particle size of from about 5 microns to about 7 microns. Finer grained and brighter deposits may be obtained where relatively finer grained alloy powders are used, but the problems of alloy powder dissolution in an acidic plating medium and fire hazards (due to the pyrophoric nature of very finely divided powders) increase as particle size decreases. Larger alloy powder particle sizes can be utilised in this invention, but this will result in rougher deposits of the final plated alloy coating.

The process of this invention thus involves the application of mechanical forces to very small particles of zinc-manganese and/or zinc-aluminium alloys, in the further presence of an immersion metal salt that is effective to immerse upon and coat the zinc-manganese and/or zinc aluminium particles. The process is carried out in an aqueous acidic media with chemical additives that clean the substrates to be plated, assist in the coating of the immersion metal upon the zinc alloy particles and promote the adhesion of the impacted particles to the substrate surfaces. Thus, the alloy powder, the aqueous media, the impaction media, the immersion metal salt and the substrates to be plated are combined appropriately in a rotating ball mill in order to accomplish the plating.

The zinc alloy particles useful in this process are selected from the group consisting of metallic alloys comprised of mixtures zinc, aluminium, and manganese. Specific examples include, zinc-aluminium alloys, zinc-manganese alloys, zinc aluminium ternary or higher alloys and zinc-manganese ternary or higher alloys. The alloy powders used in the process of the invention will preferably have a particles size distribution ranging from about 3.5 microns to about 11.6 microns with a mean particle size of from about 5 microns to about 7 microns.

The immersion metal salt is selected such that it is capable of immersion plating an adherent layer of immersion metal upon the zinc alloy particles, and preferably on the substrate to be mechanically plated. Preferably tin (II) salts such as stannous oxide or stannous chloride are used for this purpose. Copper salts may preferably be used in addition to the foregoing tin (II) salts. It is particularly preferred to immersion plate steel substrates with copper, prior to further immersion plating tin on the substrates. The concentration of immersion metal salt in the acidic aqueous media should be sufficient to adherently plate a thin, continuous and adherent coating of the immersion metal on the zinc alloy particles as well as on the substrates to be plated and may range from about 0.1 gram to 20 grams of immersion metal per square meter of surface to be plated. The immersion metal salt may be added in increments. It is, however, important to the function of this process that sufficient immersion metal salts be added such that the zinc alloy powder particles are effectively coated with the immersion metal. Coating the substrates to be plated is also preferred, but is not alone sufficient. In the alternative the zinc alloy powder particles can be coated with tin prior to their inclusion in the mechanical plating process.

The acidic aqueous media may contain an aqueous mixture of acids, such as citric acid, tartaric acid, and/or inorganic acids such as sulphuric, hydrochloric, or phosphoric acids in combination with surfactants, water soluble polymers and corrosion inhibiting agents. The pH of the aqueous media should preferably range from about 0.5 to about 3.0 and may be adjusted further during the plating process in order to optimise the brightness of the plated deposit. Examples of suitable surfactants include nonylphenolethoxylates such as Empilan NP-9 to NP-15 (available from the Huntsman Company). Preferably, surfactants are present in an amount of from about 0.1 g to about 30.0 g per square meter of processed substrate, most preferably from about 6 g/m² to about 14 g/m². Suitable water soluble polymers include polyethylene glycols such as Carbowax 20M (available from the Union Carbide Company). Preferably, the concentration of water soluble polymers in the aqueous media is from about 0.01 gram to about 3.0 grams per square meter of substrate to be plated, most preferably from about 0.3 g/m² to about 0.8 g/m². Examples of suitable corrosion inhibiting agents to include in the aqueous media are Armohib 25 (available from the Akzo-Nobel Company) and Rodine 213 (available from Amchem, Ltd). These corrosion inhibiting agents are preferably present in the aqueous media in an amount of from 0.01 g/m² to about 5.0 g/m², most preferably from about 0.5 g/m² to about 2 g/m².

Mechanical plating utilizes the application of mechanical forces to the zinc alloy particles in order to distort the particles and essentially pound the particles onto the substrates to be plated. The impaction media is used to impart this mechanical force to the particles to be plated. Preferably the impaction media consists of glass beads having a size ranging from about 6 mm to about 0.1 mm. The amount, by volume, of the impaction media should be approximately equal to the amount, by volume, of the substrate to be plated. The particular size distribution of the impaction media will depend upon the particular alloy being plated and the size and type of substrates to be plated with the alloys. For example, in plating typical bolts with the alloys disclosed in this invention, 4 parts, 5 mm beads, 2 parts, 2 mm beads, 1 part 0.5 mm beads and 1 part 0.2 mm beads may be used. The impaction media then imparts the necessary mechanical energy through the rotation of the mill in which the plating occurs. For the process of the invention, known plating barrels or ball mills may be effectively used.

In order to build up effective alloy coatings on the substrates to be plated, the process must achieve both adhesion of the alloy to the substrate surfaces and cohesive adhesion between each layer of alloy that is plated upon the substrate, thereby achieving sufficient thickness of the alloy being plated. The composition of the aqueous media and the size distribution of the impaction media have an impact upon these adhesion values and should be optimised for the alloy and substrate to be plated.

The mechanical plating process according to the invention will preferably include the following process steps:

1. The substrate to be coated with the desired alloy (e.g. steel fasteners) is placed into a rotating barrel together with water, the impact media, acid, surfactants, water soluble polymers, and corrosion inhibitors. The pH of the medium is preferably from about 0.5-3.0;

2. A copper salt such as the copper sulphate, copper chloride or copper oxide, is added preferably in an amount from about 0.1 g/m² to about 15 g/m² (preferably from about 3 g/m² to about 6 g/m²), in order to produce a thin flash deposit of copper on the substrate;

3. A salt of an immersion metal, such as tin (II) oxide or tin (II) chloride is added in an amount of from about 0.01 g/m² to about 5.0 g/m² (preferably from about 0.5 g/m² to about 1.5 g/m²). An addition of zinc powder of from about 0.1 gm² to about 20 g/m² (preferably from about 3 g/m² to about 7 g/m²) is then added to initiate the deposition of a thin flash deposit of tin on the copper plated substrate;

4. The desired alloy powder is combined with a salt of an immersion metal, such as tin (II) oxide, tin (II) chloride or tin (II) fluoride, and added in incremental additions to the barrel in order to produce the desired alloy thickness. The immersion metal is added in an amount of from 0.5 g/m² to 20 g/m², (preferably from 2.0-6.0 g/m²). The immersion metal is added in order coat the zinc alloy metal powders. The coating acts to prevent oxidation of the alloy particles and facilitates adhesion of the particles to the metal substrate. In the specific case of aluminium-zinc alloy powders, it is beneficial to add a source of fluoride ions. Salts such as sodium fluoride, sodium bifluoride, or tin (II) fluoride can be used (other sources of fluoride may be equally viable). These are added in a quantity of from about 0.1 g/m² to about 15 g/m² (and preferably from about 2.0 g/m² to about 6 g/m²) and are added to increase the rate of deoxidation of the alloy powders;

5. The pH of the plating solution is preferably raised to from about 2 to about 3 and the substrate(s) (i.e. parts being plated) are rotated in the barrel, to increase the brightness of the deposited alloy; and

6. The parts are separated from the impact media, chromated and dried.

Generally enough, liquid is added to the plating barrel to give a small reservoir of liquid in front of the impact media/metal substrates during rotation. Chemical and alloy powder additions are normally made to this reservoir.

The following examples are illustrative of the invention, but should not be taken as limiting in any way:

### EXAMPLE 1

2 kgs of M8 25 mm, bolts and 3 kgs of glass bead media were added to a 14 inch (36 cm) open ended barrel. Enough water was added to give a small reservoir of liquid at the front of the media during rotation. All chemical and powder additions were made to this reservoir.

The barrel was rotated at approximately 25 rpm.

1. 12 g of sulphuric acid, 1.5 ml of hydrochloric acid, 2 g of a Empilan NP-15 and 60 mg of Rodine 213 (a corrosion inhibitor) were added to the barrel and mixed for 10 minutes. This step degreases and cleans the work and creates the correct conditions for subsequent mechanical plating.

2. 1 g of copper sulphate pentahydrate was added and mixed for 5 min. A copper film was deposited on the work. This stage facilitates the subsequent deposition of the metal alloy powder.

3. 0.4 g of stannous oxide, 20 mg of Carbowax 20M and a further 90 mg of Rodine 213 were added to the barrel and mixed for 1 min.

4. 1 g of zinc powder was added to the barrel and mixed for 5 min. A thin immersion coating of tin was deposited.

5. 15 g of an alloy powder having a composition of 80% zinc, 20% aluminium was mixed with 0.8 g of tin (II) oxide and then added to the plating barrel in 10 equal portions over a period of 10 minutes at 1 minute intervals.

6. After additions, the parts were mixed for a further 15 minutes to complete the plating process.

7. The water reservoir was drained and the media and bolts washed. The bolts were sieved from the media and dried.

The resultant parts were bright and uniform in appearance. The coating was tested to ensure that it was coherent and adherent to the steel substrate by applying the adhesive side of a piece of adhesive tape to the surface of the coating, and then removing the tape. The adhesive side of the tape was examined visually and it was found that substantially none of the coating had adhered to the tape. The coating was thus clearly coherent and adherent to the steel substrate.

After processing, a sample of the bolts corresponding to approximately 5% of the total load was weighed. The deposit was then stripped from these bolts and they were re-weighed. From the weight of deposit on these bolts, the amount of metal powder deposited on the entire load was estimated. This was compared to the total amount of powder added and the plating efficiency was estimated. The plating efficiency was found to be 55%.

### EXAMPLE 2

2 kgs of M8 25 mm, bolts were plated in the barrel using the conditions defined in Example 1. The addition of chemicals and powders were as follows:

1. 12 g of sulphuric acid, 1.5 ml of hydrochloric acid, 2 g of a Empilan NP-15 and 60 mg of Rodine 213 (a corrosion inhibitor) were added to the barrel and mixed for 10 minutes.

2. 1 g of copper sulphate pentahydrate was added and mixed for 5 min. A copper film was deposited on the work.

3. 0.4 g of stannous oxide, 20 mg of Carbowax 20M and a further 90 mg of Rodine 213 were added to the barrel and mixed for 1 min.

4. 1 g of zinc powder was added to the barrel and mixed for 5 min. A thin immersion coating of tin was deposited.

5. 15 g of an alloy powder having a composition of 80% zinc, 20% aluminium was mixed with 0.8 g of tin (II) oxide and 1.5 g of sodium fluoride, and then added to the plating barrel in 10 equal portions over a period of 10 minutes at 1 minute intervals.

6. After additions, the parts were mixed for a further 15 minutes to complete the plating process.

7. The water reservoir was drained and the media and bolts washed. The bolts were sieved from the media and dried.

The resultant parts were bright and uniform in appearance. The coating was tested with adhesive tape as described in Example 1 and was found to have satisfactory cohesion and adhesion. The plating efficiency was found to be 73% and is higher than that of Example 1. Not wishing to be bound by theory, it appears that the inclusion of fluoride ion aids in the deoxidation of the zinc-aluminium alloy powder and results in an increase in the plating efficiency.

A sample of the bolts was subjected to surface analysis using a Scanning Electron Microscope equipped with Energy Dispersive X-ray Analysis. The average surface composition was determined to be 80.6% zinc, 13.6% aluminium and 5.8% tin.

The structure through the deposit was assessed by cutting a microsection through a bolt head and examining it's surface using an SEM instrument. The structure showed the bolt coating to have a thickness of between 12 and 18 microns. The image shows that the powders have been well compressed or ‘cold-welding’ onto the surface. (FIG. 1).

[image]

The bolts were then subjected to neutral salt spray testing in accordance with ASTM B-117. The uncoated bolts achieved 244 hrs to the first signs of red corrosion. A sample of bolts were passivated with an acidic solution containing trivalent chromium ions (Tripass ELV 2000, supplied by Macdermid Inc.). In this case the first signs of red corrosion were seen after 580 hrs.

### EXAMPLE 3

2 kgs of M8 25 mm, bolts were plated in the barrel using the conditions defined in Example 1. The addition of chemicals and powders were as follows:

1. 12 g of sulphuric acid, 2 g of a Empilan NP-15 and 60 mg of Rodine 213 (a corrosion inhibitor) were added to the barrel and mixed for 10 minutes.

2. 1 g of copper sulphate pentahydrate was added and mixed for 5 min. A copper film was deposited on the work.

3. 0.4 g of stannous oxide, 20 mg of Carbowax 20M and a further 90 mg of Rodine 213 were added to the barrel and mixed for 1 min.

4. 1 g of zinc powder was added to the barrel and mixed for 5 min. A thin immersion coating of tin was deposited.

5. 15 g of an alloy powder having a composition of 90% zinc, 10% manganese was mixed with 0.8 g of tin (II) oxide and then added to the plating barrel in 10 equal portions over a period of 10 minutes at 1 minute intervals.

6. After additions, the parts were mixed for a further 15 minutes to complete the plating process.

7. The water reservoir was drained and the media and bolts washed. The bolts were sieved from the media and dried.

The resultant parts were bright and uniform in appearance. The coating was tested with adhesive tape as described in Example 1 and was found to have satisfactory cohesion and adhesion. The plating efficiency was measured as 56%.

The average surface composition was determined to be 89.2% zinc, 8.3% manganese and 2.5% tin. A microsection of the bolt head showed the coating to be between 10 and 18 microns in thickness and have well compacted structure.

The bolts were then subjected to neutral salt spray testing in accordance with ASTM B-117. The uncoated bolts achieved 96 hrs to the first signs of red corrosion. A sample of bolts were passivated in Tripass ELV 2000 (from Macdermid Inc.). The passivated bolts achieved 480 hours to first signs of red corrosion.

### EXAMPLE 4

2 kgs of M8 25 mm, bolts were plated in the barrel using the conditions defined in Example 1. The addition of chemicals and powders were as follows:

1. 12 g of sulphuric acid, 2 g of a Empilan NP-15 and 60 mg of Rodine 213 (a corrosion inhibitor) were added to the barrel and mixed for 10 minutes.

2. 1 g of copper sulphate pentahydrate was added and mixed for 5 min. A copper film was deposited on the work.

3. 0.4 g of stannous oxide, 20 mg of Carbowax 20M and a further 90 mg of Rodine 213 were added to the barrel and mixed for 1 min.

4. 1 g of zinc powder was added to the barrel and mixed for 5 min. A thin immersion coating of tin was deposited.

5. 15 g of an alloy powder having a composition of 90% zinc, 10% manganese was mixed with 0.8 g of tin (II) oxide and 0.6 g of sodium fluoride and then added to the plating barrel in 10 equal portions over a period of 10 minutes at 1 minute intervals.

6. After additions, the parts were mixed for a further 15 minutes to complete the plating process.

7. The water reservoir was drained and the media and bolts washed. The bolts were sieved from the media and dried.

The resultant parts were bright and uniform in appearance. The coating was tested with adhesive tape as described in Example 1 and was found to have satisfactory cohesion and adhesion. The plating efficiency was measured as 62%. The presence of fluoride ions does not appear to significantly increase the plating efficiency when used in combination with zinc-manganese alloy powders.

### EXAMPLE 5

2 kgs of M8 25 mm, bolts were plated in the barrel using the conditions defined in Example 1. The addition of chemicals and powders were as follows:

1. 12 g of sulphuric acid, 2 g of a Empilan NP-15 and 60 mg of Rodine 213 (a corrosion inhibitor) were added to the barrel and mixed for 10 minutes.

2. 1 g of copper sulphate pentahydrate was added and mixed for 5 min. A copper film was deposited on the work.

3. 0.4 g of stannous oxide, 20 mg of Carbowax 20M and a further 90 mg of Rodine 213 were added to the barrel and mixed for 1 min.

4. 1 g of zinc powder was added to the barrel and mixed for 5 min. A thin immersion coating of tin was deposited.

5. 15 g of an alloy powder having a composition of 90% zinc, 8% manganese, and 5% aluminium was mixed with 0.8 g of tin (II) oxide and then added to the plating barrel in 10 equal portions over a period of 10 minutes at 1 minute intervals.

6. After additions, the parts were mixed for a further 15 minutes to complete the plating process.

7. The water reservoir was drained and the media and bolts washed. The bolts were sieved from the media and dried.

The resultant parts were bright and uniform in appearance. The coating was tested with adhesive tape as described in Example 1 and was found to have satisfactory cohesion and adhesion. The plating efficiency was measured as 63%. The average surface composition was determined to be 76.3% zinc, 6.4% manganese, 4.6% aluminium and 12.6% tin.

### EXAMPLE 6

2 kgs of MS 25 mm, bolts were plated in the barrel using the conditions defined in Example 1. The addition of chemicals and powders were as follows:

1. 12 g of sulphuric acid, 2 g of a Empilan NP-15 and 60 mg of Rodine 213 (a corrosion inhibitor) were added to the barrel and mixed for 10 minutes.

2. 1 g of copper sulphate pentahydrate was added and mixed for 5 min. A copper film was deposited on the work.

3. 0.4 g of stannous oxide, 20 mg of Carbowax 20M and a further 90 mg of Rodine 213 were added to the barrel and mixed for 1 min.

4. 1 g of zinc powder was added to the barrel and mixed for 5 min. A thin immersion coating of tin was deposited.

5. 15 g of an alloy powder having a composition of 75% zinc, 20% aluminium and 5% tin was mixed with 0.8 g of tin (II) oxide and 0.8 g of sodium fluoride and then added to the plating barrel in 10 equal portions over a period of 10 minutes at 1 minute intervals.

6. After additions, the parts were mixed for a further 15 minutes to complete the plating process.

7. The water reservoir was drained and the media and bolts washed. The bolts were sieved from the media and dried.

The resultant parts were bright and uniform in appearance. The coating was tested with adhesive tape as described in Example 1 and was found to have satisfactory cohesion and adhesion. The plating efficiency was measured as 67%. The average surface composition was determined to be 70.8% zinc, 14.9% tin and 14.3% aluminium.

### COMPARATIVE EXAMPLE 1

2 kgs of M8 25 mm, bolts were plated in the barrel using the conditions defined in Example 1. The addition of chemicals and powders were as follows:

1. 12 g of sulphuric acid, 2 g of a Empilan NP-15 and 60 mg of Rodine 213 (a corrosion inhibitor) were added to the barrel and mixed for 10 minutes.

2. 1 g of copper sulphate pentahydrate was added and mixed for 5 min. A copper film was deposited on the work.

3. 0.4 g of stannous oxide, 20 mg of Carbowax 20M and a further 90 mg of Rodine 213 were added to the barrel and mixed for 1 min.

4. 1 g of zinc powder was added to the barrel and mixed for 5 min. A thin immersion coating of tin was deposited.

5. 15 g of an alloy powder having a composition of 80% zinc, 20% aluminium was added to the plating barrel in 10 equal portions over a period of 10 minutes at 1 minute intervals.

6. After additions, the parts were mixed for a further 15 minutes to complete the plating process.

7. The water reservoir was drained and the media and bolts washed. The bolts were sieved from the media and dried.

The resultant parts were dull and patchy in appearance. The coating was tested with adhesive tape as described in Example 1 and was found to have satisfactory cohesion and adhesion. However, the plating efficiency, measured at 21%, was significantly lower than that found in Examples 1 and 2.

The structure of the deposit was examined by SEM and by optical microsopy. The structure of the coating shows evidence of poor compaction of the powders on the surface. The coating formed also had areas where the coating was thin or where no coating was no evident.

This example illustrates the importance of including sufficient immersion salts (such as tin (II) oxide) in the plating process so that the zinc-alloy powder particles are effectively coated with the immersion metal. Immersion coating of the substrate alone is not sufficient.

### COMPARATIVE EXAMPLE 2

2 kgs of M8 25 mm, bolts were plated in the barrel using the conditions defined in Example 1. The addition of chemicals and powders were as follows:

1. 12 g of sulphuric acid, 2 g of a Empilan NP-15 and 60 mg of Rodine 213 (a corrosion inhibitor) were added to the barrel and mixed for 10 minutes.

2. 1 g of copper sulphate pentahydrate was added and mixed for 5 min. A copper film was deposited on the work.

3. 0.4 g of stannous oxide, 20 mg of Carbowax 20M and a further 90 mg of Rodine 213 were added to the barrel and mixed for 1 min.

4. 1 g of zinc powder was added to the barrel and mixed for 5 min. A thin immersion coating of tin was deposited.

5. 15 g of an alloy powder having a composition of 90% zinc, 10% manganese was added to the plating barrel in 10 equal portions over a period of 10 minutes at 1 minute intervals.

6. After additions, the parts were mixed for a further 15 minutes to complete the plating process.

7. The water reservoir was drained and the media and bolts washed. The bolts were sieved from the media and dried.

The resultant parts were dull and patchy in appearance. The coating was tested with adhesive tape as described in Example 1 and was found to have unsatisfactory cohesion and adhesion. The plating efficiency was measured as 38%.

Examination of a microsection through the part revealed poor compaction of the powders on the surface and areas with little or no deposit.

This example again illustrates the importance of including sufficient immersion salts (such as tin (II) oxide) in the plating procedure so that the zinc alloy power particles are effectively coated with the immersion metal. Immersion coating of the substrate alone is not sufficient.

We claim:

1. A process for mechanically plating a zinc alloy deposit onto a metal substrate, said process comprising:
(a) providing an aqueous media comprising, the metal substrate and impaction media, in a rotatable drum;
(b) adding an immersion metal salt and zinc alloy powder particles to the aqueous media such that the zinc alloy powder particles are immersion plated with an immersion metal from the immersion metal salt; and
(c) rotating the drum such that the zinc alloy powder particles are mechanically plated upon the metal substrate.

2. A process according to claim 1 wherein the immersion metal salt is a tin II salt.

3. A process according to claim 1 wherein the zinc alloy powder particles comprise a zinc-manganese alloy.

4. A process according to claim 1 wherein the zinc alloy powder particles comprise a zinc-aluminium alloy.

5. A process according to claim 1 wherein the zinc alloy powder particles comprise particles in the size range of from about 3 to about 20 microns.

6. A process according to claim 2 wherein the zinc alloy powder particles comprise a zinc-manganese alloy.

7. A process according to claim 2 wherein the zinc alloy powder particles comprise a zinc-aluminium alloy.

8. A process according to any one of claims 1, 2, 3, 4, 5, 6, or 7 wherein the aqueous media also comprises a source of fluoride ions.

9. A process for mechanically plating a zinc alloy deposit onto a metal substrate, said process comprising:
(a) providing an aqueous media, comprising the metal substrate and impaction media, in a rotatable drum;
(b) adding zinc alloy powder particles to the aqueous media;
(c) rotating the drum such that the zinc alloy powder particles are mechanically plated upon the metal substrate;
wherein the zinc alloy powder particles are coated with a deposit comprising tin.

10. A process according to claim 9 wherein the zinc alloy powder particles comprise a zinc-manganese alloy.

11. A process according to claim 9 wherein the zinc alloy powder particles comprise a zinc-aluminium alloy.

12. A process according to claim 9 wherein the zinc alloy powder particles comprise particles in the size range of from about 3 to about 20 microns.

13. A process according to any one of claims 9, 10, 11, or 12 wherein the aqueous media also comprises a source of fluoride ions.
